(19) United States
(12) Patent Application Publication
(10) Pub. No.: US 2024/0007499 A1
(43) Pub. Date: Jan. 4, 2024

(54) Systems and methods for preventing malicious script attacks

(71) Applicant: Lavakumar Kuppan, Chennai (IN)

(72) Inventor: Lavakumar Kuppan, Chennai (IN)

(21) Appl. No.: 18/346,829

(22) Filed: Jul. 4, 2023

Related U.S. Application Data
(60) Provisional application No. 63/367,620, filed on Jul. 4, 2022.

(51) Int. Cl. H04L 9/40; G06F 9/54

(52) U.S. Cl. CPC H04L 63/1466; G06F 9/547; H04L 63/1416

(57) ABSTRACT

Embodiments herein disclose secured systems and methods for preventing malicious script attacks. The system mainly comprises a script analysis unit (configured in a server), and a global abstraction unit and a script abstraction unit (which are configured and implemented in a user device through an application). The script analysis unit can generate global policy(ies) and script-level policy(ies) which define the permissions for individual scripts and the default permission level. The global abstraction unit can create abstracted APIs based on the global policy and script-level policy. The script abstraction unit can process the scripts through the server, and the processed scripts are allowed to call critical native web APIs based on permission policies. Thus, embodiments herein allow the customers to protect their websites by executing each script code with a permission policy.

### CROSS REFERENCE TO RELATED APPLICATION

This application is based on and derives the benefit of U.S. Provisional Application 63/367,620, the contents of which are incorporated herein by reference.

### TECHNICAL FIELD

The embodiments herein relate to cybersecurity systems and methods, and, more particularly, to permission based secured systems for executing each individual script code at the client side in a safe browser environment.

### BACKGROUND

In general, web pages may include code in a language (such as, but not limited to, JavaScript), to be executed when the page is loaded on a user device in a browser. All the scripts included in a webpage may run with the same level of privileges, irrespective of whether they are written by the site owners, libraries or third party codes (like analytics or advertising providers).

Malicious scripts are malicious programs or codes written in a script language. For example, attackers may create malicious script targeting a website and include that malicious script in one or more webpages of the target site from a remote server. These embedded scripts may then automatically initiate and execute to exploit one or more aspects of a user's web browser when the user accesses the targeted webpage.

Current approaches focus on sandboxing individual scripts. However, this approach has some fundamental flaws as these sandboxes can be bypassed by security researchers. This approach also requires marking specific scripts for sandboxing, and allowing other scripts to run with full privileges.

Other systems perform resource intensive operations to apply restrictions on what certain scripts can do in the page. However, this involves generating a stack trace, parsing the generated stack trace, and comparing the parsed stack trace against a policy, to determine if a script is malicious or not.

### BRIEF DESCRIPTION OF THE FIGURES

The embodiments disclosed herein will be better understood from the following detailed description with reference to the drawings, in which:

FIG. 1 depicts an example block diagram illustrating a secured system for executing script(s) in a webpage, according to embodiments as disclosed herein;

FIG. 2 depicts an example flowchart illustrating a method for generating a global policy and script-level policy, by using a script analysis unit, according to embodiments as disclosed herein;

FIG. 3 depicts an example flowchart illustrating a method for granting access to web APIs, by using a global abstraction unit, according to embodiments as disclosed herein; and

FIG. 4 depicts an example flowchart illustrating a method for executing the processed script in the webpage, by using the script abstraction unit, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

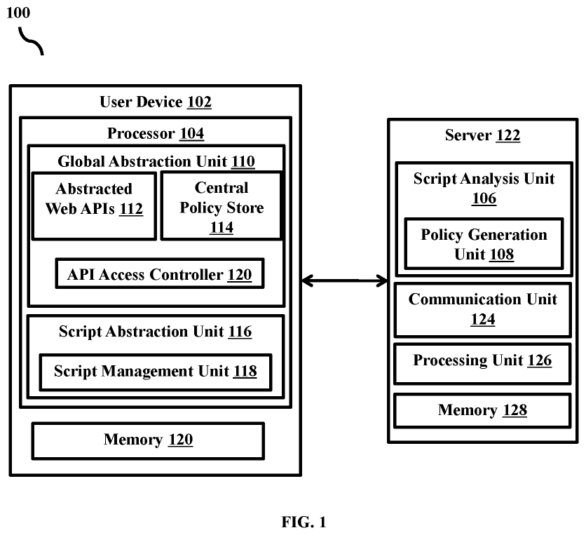

The embodiments herein disclose systems and methods for preventing malicious script attacks by assigning permissions to all individual scripts in a webpage. Referring now to the drawings, and more particularly to FIGS. 1 through 4, where similar reference characters denote corresponding features consistently throughout the figures, there are shown embodiments.

FIG. 1 depicts an example block diagram illustrating a secured system 100 for executing script(s) in a webpage, according to embodiments as disclosed herein. The secured system 100 can be implemented in a user device 102, where one or more system components can be executed in a processor 104. The user device 102 can be any device that can load a webpage. Examples of the user device 102 can be, but not limited to, a mobile phone, a smart phone, a computer, a laptop, a tablet, a wearable device, an Internet of Things (IoT) device, or any other device that can load at least one webpage. A user may use the user device 102 to access the internet and/or webpages through the processor 104. The user device 102 may further comprise one or more displays and one or more input/output units (not shown).

The system components may be, for example, computer program code units that provide services not ordinarily available to web-based code, such as JavaScript, in the processor 104. The user device 102 can communicate with a server 122. The system components are made available to a user supplied browser based program code, e.g., JavaScript code which can be downloaded from the server 122 as part of a web page.

The user device 102 further comprises a memory 120. The memory 120 stores at least one of, the system components, cached web pages, one or more instructions, and so on. Examples of the memory 120 may be, but are not limited to, NAND, embedded Multimedia Card (eMMC), Secure Digital (SD) cards, Universal Serial Bus (USB), Serial Advanced Technology Attachment (SATA), solid-state drive (SSD), and so on. Further, the memory 120 may include one or more computer-readable storage media. The memory 120 may include one or more non-volatile storage elements. Examples of such non-volatile storage elements may include Random Access Memory (RAM), Read Only Memory (ROM), magnetic hard discs, optical discs, floppy discs, flash memories, or forms of electrically programmable memories (EPROM) or electrically erasable and programmable (EEPROM) memories. In addition, the memory 120 may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that may, over time, change (e.g., in Random Access Memory (RAM) or cache).

The term ‘processor 104’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. For example, the processor 104 may include at least one of, a single processer, a plurality of processors, multiple homogeneous or heterogeneous cores, multiple Central Processing Units (CPUs) of different kinds, microcontrollers, special media, and other accelerators.

In an embodiment, the processor 104 can comprise one or more applications that enables a user to access web scripts, such as, but not limited to, a browser. Examples of the browser can be at least one of, but not limited to, a Chrome, Internet Explorer, Edge, Firefox, Safari, or Opera. The processor 104 can execute one or more scripts of a web page. In an example herein, the processor 104 may support scripts in a language such as, but not limited to, JavaScript. The processor 104 allows scripts of the web page to access one or more Application Program Interfaces (APIs). The script may access a web API through an API call and provide one or more arguments to the web API. Upon receiving the API call, the web API may then execute one or more actions based on the arguments received.

The memory 120 includes web pages received from the user side web server. The web pages may include or reference user-supplied JavaScript code. The JavaScript code is an example of browser-based code, which may be computer program code and may be invoked, by the processor 104.

In an embodiment, the server 122 is a device capable of processing and executing the data received from the components of the secured system 100. The server 122 may be a local server or a remote server. The server 122 may also be a cloud server that can be accessed through a communication network.

The server 122 may comprise a script analysis unit 106, a communication unit 124 for enabling communication between the server 122 and the system components, a processing unit 126 for executing and processing instructions from the system components, and a memory 128 for storing data executed by the processing unit 126.

In an embodiment, the script analysis unit 106 is configured to analyze the web pages of a website running in the processor 104 to identify behaviour of the scripts that are loaded by the pages, details of web APIs used by the scripts, and how the interaction is carried out between the scripts and the web APIs. The script analysis unit 106 analyzes the web pages which are required to be protected based on user requirement.

The script analysis unit 106 collects the analyzed script details and generates a global policy and script-level policy using a policy generation unit 108 which define the permissions for individual scripts and the default permission level. The global policy is generated for any script running on the web page. The script-level policy is generated specifically for a script. Thus, each script running on the web page is provided with unique permissions.

For example, once the customer provides the website details to be monitored, the script analysis unit 106 analyzes the website. Thereafter, the script analysis unit 106 generates the global and script-level policies for all the scripts on the website. During this analysis stage, all the scripts that are loaded in the HTML of the web page are simultaneously identified and sent to the processing unit 126.

The script analysis unit 106 can be either integrated in the continuous integration or continuous delivery (Cl/CD) pipeline or a dedicated site browsing activity.

The term ‘processing unit 126’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. For example, the processing unit 126 may include at least one of, a single processer, a plurality of processors, multiple homogeneous or heterogeneous cores, multiple Central Processing Units (CPUs) of different kinds, microcontrollers, special media, and other accelerators. The processing unit 126 can be configured to execute instructions stored in the memory 128.

In an embodiment, the processing unit 126 receives the original scripts from the script analysis unit 106, processes the scripts and provides a processed version of the scripts. Thus, original scripts can be processed in the server 122. The processed version of the scripts can be automatically loaded in a script management unit 118 of the script abstraction unit 116 along with the original script logic and the URL of the scripts.

The memory 128 stores at least one of, the global and script-level permission policies which are generated by the policy generation unit 108, cached web pages, scripts, and so on. Examples of the memory 128 may be, but are not limited to, NAND, embedded Multimedia Card (eMMC), Secure Digital (SD) cards, Universal Serial Bus (USB), Serial Advanced Technology Attachment (SATA), solid-state drive (SSD), and so on. Further, the memory 128 may include one or more computer-readable storage media. The memory 128 may include one or more non-volatile storage elements. Examples of such non-volatile storage elements may include Random Access Memory (RAM), Read Only Memory (ROM), magnetic hard discs, optical discs, floppy discs, flash memories, or forms of electrically programmable memories (EPROM) or electrically erasable and programmable (EEPROM) memories. In addition, the memory 128 may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that may, over time, change (e.g., in Random Access Memory (RAM) or cache).

The processor 104 comprises a global abstraction unit 110 and a script abstraction unit 116. In an embodiment, the global abstraction unit 110 can be loaded by the page with access to the global policy and the script-level policy generated by the script analysis unit 106. The global abstraction unit 110 can be a self-contained library that is loaded preferably as a first or one of the first scripts in a webpage. This script creates a layer of abstraction over critical native Web APIs, monitors critical functions in the webpage and exposes functionality. The global abstraction unit 110 contains code for abstraction and the policies generated. In an example herein, the global abstraction unit 110 can be a self-contained JavaScript library.

The global abstraction unit 110 can create a layer of abstraction over critical native Web APIs and grant access to the abstracted Web APIs 112 based on global policy(ies) and script-level policy(ies). The global abstraction unit 110 can store the critical native Web APIs, and can overwrite the critical native Web APIs with modified version of the Web APIs i.e., abstracted Web APIs. The global abstraction unit 110 can comprise a central policy store 114. The central policy store 114 can store the default global policy and script-level permission policies for the different scripts in the web page.

The central policy store 114 can further comprise one or more pre-declared script-level policies based on the URL of the script, host name serving the script or any other parameters that can be used to categorize scripts. The pre-declared script-level policies include permission files which may be declared inside the global abstraction unit 110 or retrieved from the server 122 by the global abstraction unit 110. The global abstraction unit 110 along with the pre-declared script-level policies is loaded from the server 122. Further, the central policy store 114 of the global abstraction unit 110 may access pre-declared script-level policies from the memory 128 of the server 122.

The global abstraction unit 110 can comprise an API access controller 120 to receive the abstracted Web APIs 112. On script registration being successfully completed, the API access controller 120 can transmit the copy of the abstracted Web APIs 112 to the script abstraction unit 116. For example, during script registration using a script ID, the global abstraction unit 110 generates a copy of the globally abstracted web API 112. The API access controller 120 can call the globally abstracted web API 112 for calling critical native web APIs, based on permission policies.

In an embodiment, each processed script can be automatically loaded in the web page through the script management unit 118 of the script abstraction unit 116. The script abstraction unit 116 can create a unique execution environment for the scripts loaded in the web page using features of the language. In an example herein, if the language being used is JavaScript, the script abstraction unit 116 can create a unique execution environment for the scripts loaded in the web page using JavaScript language features, wherein the examples of the JavaScript language features may comprise closure, shadowRealms API, and so on.

In an embodiment, if a script dynamically loads another script, then the processing unit 126 can automatically process the new script. Thereafter, the processing unit 126 can automatically assign the processed script with the same permission policy as of the script that dynamically loads this new script, which can be then loaded into the web page.

In an embodiment, the script management unit 118 can generate unique script IDs for each individual processed script. The script management unit 118 can register each script using the generated unique script IDs along with optional script policies with the global abstraction unit 110 for obtaining the abstracted Web APIs 112. The global abstraction unit 110 can provide the abstracted Web APIs 112 which can be specially created for each script. The script abstraction unit 116 can route any calls made to the critical native web APIs by a particular script, to the API access controller 120 along with the unique script IDs. The API access controller 120 can verify which script calls the critical native Web APIs. Further, the API access controller 120 can verify its policy from the pre-declared script-level policies which are stored in the central policy store 114 for the corresponding script ID. Based on the policy existence, the API access controller 120 can decide whether the call can be routed to the critical native web API, otherwise the call can be rejected.

In an embodiment, the proposed secured system 100 may comprise similar components such as the server 122 components which may include the processing unit, the communication unit, and the memory, for accomplishing system operations and communicating with the server 122.

The communication units of the global abstraction unit 110, the script abstraction unit 116, and the server 122 may be wired or wireless including, but not limited to, GPS, GSM, LAN, Bluetooth, Wi-Fi, a short-range wireless communication a medium-range wireless communication or a long-range wireless communication, according to the usage environment. In an embodiment, a communication network may be utilized to accomplish communication between the system components and the server 122.

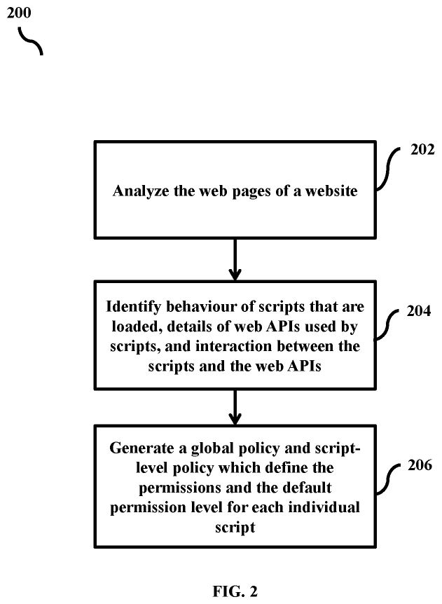

FIG. 2 depicts an example flowchart illustrating a method 200 for generating a global policy and script-level policy, by using the script analysis unit of the server, according to embodiments as disclosed herein. The method 200 begins with analyzing the web pages of a website of the application running in the user device, as depicted in step 202. Subsequently, various parameters such as behaviour of the scripts that are loaded by the pages, details of the web APIs used by the scripts, and how the interaction is been carried out between the scripts and the web APIs are identified, as depicted in step 204. Thereafter, based on the identified parameters, a global policy and a script-level policy is generated, which defines the permissions and the default permission level for each individual script, as depicted in step 206. The permissions indicate what the script can do and to what extent the script may be allowed to execute on the user device 102 etc. The generated global policy and script-level policy can be stored in the memory 128 and/or the memory 120, which can be retrieved by the central policy store 114 of the global abstraction unit 110. The various actions in method 200 may be performed in the order presented, in a different order or simultaneously. Further, in some embodiments, some actions listed in FIG. 2 may be omitted.

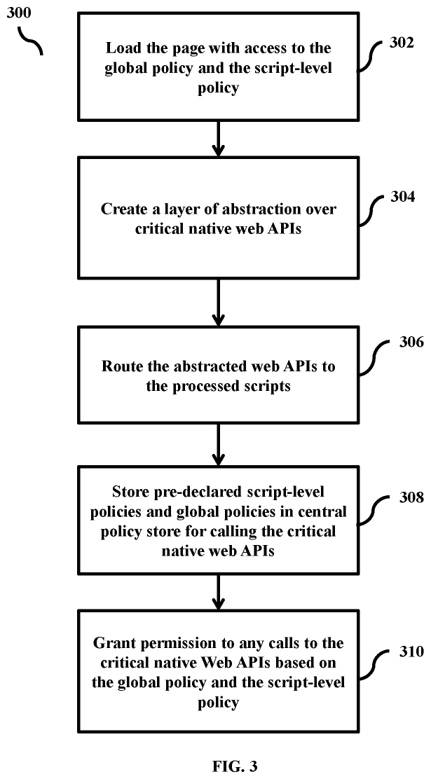

FIG. 3 depicts an example flowchart illustrating a method 300 for granting access to web APIs, by using the global abstraction unit, according to embodiments as disclosed herein. The method 300 begins with loading the web page with access to the global policy and the script-level policy, as depicted in step 302, which are stored in the central policy store 114. Subsequently, a layer of abstraction is created over critical native web APIs for each script, as depicted in step 304. Thereafter, the abstracted Web APIs are routed to the processed scripts which are registered with the global abstraction unit 110, as depicted in step 306. Each processed script can be loaded from the script abstraction unit 116 and registered with the global abstraction unit 110 using unique script IDs. Later, pre-declared script-level policies and global policies are stored in the central policy store 114 for calling the critical native web APIs, as depicted in step 308. Thereafter, permission to any calls to the critical native Web APIs is granted based on the global policy and the script-level policy, as depicted in step 310, using the API access controller 120. The various actions in method 300 may be performed in the order presented, in a different order or simultaneously. Further, in some embodiments, some actions listed in FIG. 3 may be omitted.

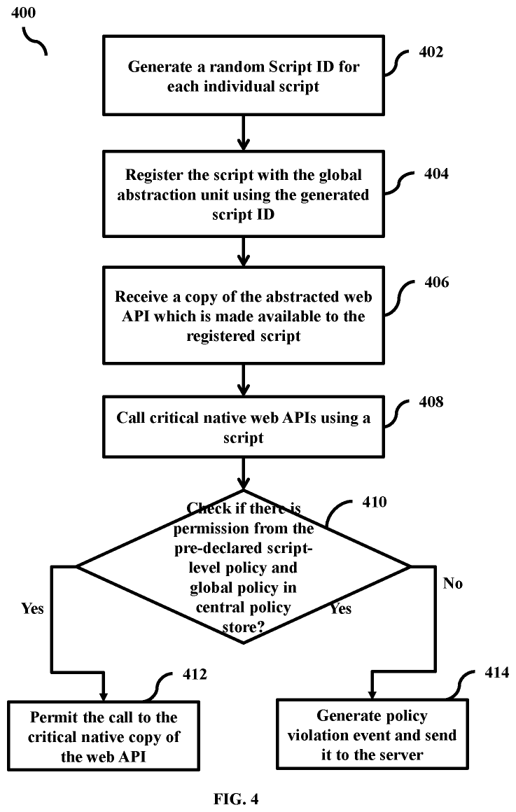

FIG. 4 depicts an example flowchart illustrating a method 400 for executing the processed script in the webpage, by using the script abstraction unit, according to embodiments as disclosed herein. The method 400 begins with a random script ID being generated for each individual processed script, wherein the script ID can be used to uniquely identify the script in the web page, as depicted in step 402, by using the script management unit. Subsequently, the processed script is registered with the global abstraction unit using the generated script ID, as depicted in step 404. If an optional script policy is generated along with the script ID, then that optional script policy is a specific policy for the script. The generated optional script policy may be considered by the global abstraction unit 110 and can be stored in the central policy store 114 for the corresponding script ID. Thereafter, a copy of the abstracted web API is received by the global abstraction unit 110. The global abstraction unit 110 makes the received copy of the abstracted web API available to the registered script, as depicted in step 406. Subsequently, when a processed script tries to call any of the critical native Web API, then the call is transmitted to the API access controller of the global abstraction unit, as depicted in step 408. Later, a check is done by the API access controller to check whether a pre-declared script-level policy and global policy exists in the central policy store, as depicted in step 410, for the script ID of the script that calls the critical native Web API. The API access controller collects the script information and checks whether a pre-declared script-level policy and global policy has been defined or not. If the global policy and the script-level policy grant permission has been defined, then the stricter of the two is used to check if the call can be permitted for the critical native copy of the web API. Subsequently, if the global policy and the script-level policy permits the call, then the critical native copy of the web API will be called, as depicted in step 412, through the API access controller and the results returned. If the global policy and the script-level policy does not permit (i.e., refuse) the action, then a policy violation event is generated and logged locally and sent to the server, as depicted in step 414. Further, depending on the configuration of the policy, the globally abstracted web API may throw an exception without calling the critical native web API or call the critical native web API. If the globally abstracted web API is called without passing the script ID, then it may refer to the default permission policy to determine how to handle the request. There are various techniques used for detecting the script calling the API, hence any technique may be used for calling the API based on the language and browser environment. In an example embodiment herein, stack trace can be a technique used for detecting the script calling the API. The various actions in method 400 may be performed in the order presented, in a different order or simultaneously. Further, in some embodiments, some actions listed in FIG. 4 may be omitted.

Further, the customers may implement the proposed secured system on the script (such as, but not limited to, Javascript) that their web application loads on the client-side, in the user's browser. In another use case, this secured system may protect end users from malicious websites or malicious JavaScript on websites, thus acting like an antivirus.

Consider the example of https://example.com. On the Script Analysis Unit 106 analyzing the site, it can be determined that this page loads only one script, examplelib.js. This page has a login form, during the analysis phase some test credentials are entered in this form and the behaviour of this form is observed. During the analysis is it found that examplelib.js is only sending Ajax requests to https://example.com. Based on this analysis, global and script-level policies are generated. Since examplelib.js only makes Ajax request to https://example.com, the script-level policy for this script will only allow Ajax calls to this one domain Since examplelib.js is the only script in the page, the global policy will not allow any Ajax calls to be made for scripts other than examplelib.js.

Consider that https://example.com is being protected by embodiments as disclosed herein. So, the script containing the Global Abstraction Unit 110 is loaded first; for example, in a script named globalabtraction.js. After this, the processed version of examplelib.js is loaded into the site. In an example scenario, consider that an attacker has injected malicious code in to examplelib.js and wants to steal the authentication credentials of users of this site. Consider that the attacker owns a server with the address https://attacker.com. The attacker will try to copy the data entered by users in the login form in https://example.com and then send this information to https://attacker.com in a Ajax request. When the attacker tries to make am Ajax request to https://attacker.com, this request will go to the Global Abstraction Unit 110. The Global Abstraction Unit 110 will see that the Ajax request is being made by examplelib.js and the script-level policy of examplelib.js only allows Ajax requests to https://example.com. Since the policy does not allow requests to https://attacker.com, this Ajax call will be blocked. And this will prevent the attacker from stealing the data entered by users in the login form.

If the attacker manages to load a new script in to the site, let's say named attackerlib.js and if this script tries to make a Ajax request to https://attacker.com, then the Global Abstraction Unit 110 will block this as well. This is because this is script was not found during the script analysis phase, so it will not have a script-level policy assigned for it. So, instead the global policy will be applied by any requests made by this script. And in this case, the global policy also does not allow any requests to https://attacker.com; so this script's attempts to send data to the attacker's server will also be blocked.

The proposed secured system assigns a permission model for each individual script, instead of sandboxing individual scripts. Thus, the system allows every call to critical native web APIs to be processed based on a permission model. If any script tries to bypass the proposed model and tries to call the web APIs directly, then the script can only call the globally abstracted web APIs, as there will be no reference available to the critical native version of the web APIs outside the global abstraction unit.

This permission model may be utilized by website owners to assign lower permissions to scripts loaded from third parties or less trusted sources. This helps to reduce the exposure to the external scripts and control their functions on the web page. Even trusted scripts can be given permission only based on their functions. This greatly reduces the impact of any vulnerability found even in trusted codes. Since, the proposed system assigns permissions to all individual scripts in a web page, if any script tries to bypass our system then it will be assigned the default permission which can be configured to be very low.

The secured system provides proxy objects to individual scripts, and this allows applying restriction on the script in a resource efficient manner. Further, the system utilizes stack trace analysis only in specific scenarios, thereby greatly improving performance. The system also provides an option to declare permission in the source code, which allows developers with the ability to control the permissions of the scripts they write or include in a website/webpage.

The embodiments disclosed herein can be implemented through at least one software program running on at least one hardware device and performing network management functions to control the network elements. The elements shown in FIG. 1 includes blocks, which can be at least one of a hardware device, or a combination of hardware device and software module.

The embodiment disclosed herein specifies a system for permission based privilege model for client-side script code. The mechanism allows the customers to protect their websites so that untrusted code may not run on their sites or execution of untrusted code can be detected by providing a system thereof. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of device which can be programmed including e.g., any kind of computer like a server or a personal computer, or the like, or any combination thereof, e.g., one processor and two FPGAs. The device may also include means which could be e.g., hardware means like e.g., an ASIC, or a combination of hardware and software means, e.g., an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiments herein may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments herein can be practiced with modification within the spirit and scope of the claims as described herein.

What is claimed is:

1. A method for preventing malicious script attacks by scripts in a webpage, the method comprising:
creating a layer of abstraction over web Application Programming Interfaces (APIs) for each script present in a webpage, on the webpage being loaded;
routing the abstracted web APIs to a plurality of previously registered processed scripts, wherein the previously registered processed scripts is loaded and registered using a script ID for each processed script; and
granting or refusing permission to a script to make a call to a web API, based on a global policy and the script-level policy.

2. The method, as claimed in claim 1, wherein the method further comprises:
analyzing at least one page of a website;
identifying one or more parameters related to the at least one page of the website, wherein the one or more parameters comprising behaviour of at least one script that are loaded by the at least one page of the website, one or more details of one or more web APIs used by the at least one script, and one or more interactions between the at least one script and the one or more APIs; and
generating the global policy and a script-level policy based on the identified parameters, wherein the global policy and a script-level policy defines permissions and a default permission level for each of the at least one script.

3. The method, as claimed in claim 1, wherein the method further comprises storing pre-declared script-level policies and global policies for calling the web APIs.

4. The method, as claimed in claim 1, wherein the method further comprises:
granting permission to the script to make the call to the web API, if the global policy and the script-level policy grants permission to the script; and
refusing permission to the script to make the call to the web API, if the global policy and the script-level policy does not grant permission to the script.

5. The method, as claimed in claim 4, wherein if the global policy and the script-level policy does not grant permission to the script, the method further comprises:
generating a policy violation event; and
logging the policy violation event.

6. The method, as claimed in claim 4, wherein the script ID is used to uniquely identify the script in the web page.

7. The method, as claimed in claim 4, wherein, then the method comprises referring to a default permission policy to determine if to grant or refuse permission to the script to make the call to the web API, if there is no script ID.

8. The method, as claimed in claim 1, wherein the method comprises of detecting the script calling the API using stack trace.

9. The method, as claimed in claim 1, wherein the permissions indicate what the script can do and to what extent the script may be allowed to execute on a user device.

10. A system for preventing malicious script attacks by scripts in a webpage, the system configured for:
creating a layer of abstraction over web Application Programming Interfaces (APIs) for each script present in a webpage, on the webpage being loaded;
routing the abstracted web APIs to a plurality of previously registered processed scripts, wherein the previously registered processed scripts is loaded and registered using a script ID for each processed script; and
granting or refusing permission to a script to make a call to a web API, based on a global policy and the script-level policy.

11. The system, as claimed in claim 10, wherein the system is further configured for:
analyzing at least one page of a website;
identifying one or more parameters related to the at least one page of the website, wherein the one or more parameters comprising behaviour of at least one script that are loaded by the at least one page of the website, one or more details of one or more web APIs used by the at least one script, and one or more interactions between the at least one script and the one or more APIs; and
generating the global policy and a script-level policy based on the identified parameters, wherein the global policy and a script-level policy defines permissions and a default permission level for each of the at least one script.

12. The system, as claimed in claim 10, wherein the system is further configured for storing pre-declared script-level policies and global policies for calling the web APIs.

13. The system, as claimed in claim 10, wherein the system is further configured for:
granting permission to the script to make the call to the web API, if the global policy and the script-level policy grants permission to the script; and
refusing permission to the script to make the call to the web API, if the global policy and the script-level policy does not grant permission to the script.

14. The system, as claimed in claim 13, wherein if the global policy and the script-level policy does not grant permission to the script, the system is further configured for:
generating a policy violation event; and
logging the policy violation event.

15. The system, as claimed in claim 13, wherein system is configured for using the script ID to uniquely identify the script in the web page.

16. The system, as claimed in claim 13, wherein, then the method comprises referring to a default permission policy to determine if to grant or refuse permission to the script to make the call to the web API, if there is no script ID.

17. The method, as claimed in claim 1, wherein the method comprises of detecting the script calling the API using stack trace.
